(19) United States
(12) Patent Application Publication
(10) Pub. No.: US 2005/0069846 A1
(43) Pub. Date: Mar. 31, 2005

(54) Non-verbal multilingual communication aid

(76) Inventor: Sylvia Acevedo, Austin, TX (US)

Correspondence Address: MCKENNA LONG & ALDRIDGE LLP;Matthew T. Bailey, 1900 K Street, N.W., Washington, DC, 20006, US

(21) Appl. No.: 10/446,020

(22) Filed: May 28, 2003

(51) Int. Cl. G09B 19/00

(52) U.S. Cl. 434/156

(57) ABSTRACT

The present invention is directed to aid in communication between persons speaking two different languages by providing a visual tool that describes a task to be performed in each language by including pictures depicting the tasks and items, such as supplies, associated with each task and text with the task name, command, or related information in at least two languages.

### BACKGROUND OF THE INVENTION

The present invention is directed to aid in communication between persons speaking two different languages by providing a visual tool that describes a task to be performed in each language by including pictures depicting the tasks and items, such as supplies, associated with each task and text with the task name, command, or related information in at least two languages.

### DESCRIPTION OF THE PRIOR ART

In certain fields and activities, persons speaking different languages may be expected to communicate to meet a goal or perform an action. Oftentimes, even if one person is proficient in another language, this level of proficiency may not be adequate for a particular tasks such as painting, for example, because terms such as molding and shutter may not be known by either person in a common language. In the past, a dictionary has been used for translation; however, a dictionary is ineffective if one person is illiterate in their language. Alternatively, if the speaker cannot pronounce the translated word correctly, incorrect instructions may be given.

### SUMMARY OF THE INVENTION

The objects of the present invention include providing a method and device for non-verbal communication between persons speaking different languages. The present invention solves the inadequacies of the prior art by allowing communication that is not based on a particular language, i.e. pictorially, however, the present invention also provides necessary phrases or words in both languages. The present invention may be accomplished in any language and for multiple tasks, such as, for example, irrigation, landscaping, painting, drywall installation, and maid service.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

To achieve the objects and in accordance with the purpose of the invention, as embodied and broadly described herein, the present invention may include, in one or more embodiments, a multilingual communication aid and a method of non-verbal communication. In a specific embodiment, the communication aid may include a plurality of demonstration surfaces, wherein each surface may contain informative information in at least two languages and may also include a pictorial representation of the informative information. In another embodiment, the communication aid may be categorized into a particular task. The particular task may include, for example, painting, irrigation, landscaping, construction, maid service, drywall installation, food service, tourism, and elder/child care.

In one embodiment of the present invention, the demonstration surfaces [5] are connected in a map-type formation shown in FIG. 1. In another embodiment, the map-type formation may be adapted to fit in a pocket. In another embodiment of the present invention, shown in FIG. 2, the demonstration surfaces may be connected in a ring-type formation. In still another embodiment of the present invention, shown in FIG. 3, the demonstration surfaces [5] may be connected in a notebook formation.

In one embodiment of the present invention, the informative information is grouped into categories. In another embodiment, the categories may include locations, instructions, questions, and supplies. In another embodiment of the present invention, the demonstration surfaces may be water-resistant. In another embodiment of the present invention, the demonstration surfaces may be tear-resistant. In another embodiment of the present invention, the demonstration surfaces are printed in a color combination that makes them difficult to photocopy.

In one embodiment of the present invention, shown in FIG. 2, the ring-type formation may include a ring and a plurality of demonstration surfaces [5] adapted to hang from the ring. In another embodiment of the present invention, the demonstration surfaces [5] are adapted to be removed from the ring. In still another embodiment, one or more demonstration surfaces are identical.

The present invention may include a method of non-verbal communication providing a communication aid that may include a plurality of demonstration surfaces. Each of these surfaces may contain informative information in at least two languages and a pictorial representation of the informative information. The method of non-verbal communication may include the steps of selecting a desired demonstration surface and indicating that the informative information is desired.

In a specific embodiment of the present invention, the indicating step may point to a particular panel. In another embodiment, the indicating step may include placing the demonstration surface in a desired location. In one embodiment of the present invention, the communication aid may be adapted to be categorized into a particular task. The particular task may include, for example, painting, irrigation, landscaping, construction, maid service, drywall installation, food service, tourism, and elder/child care.

In a specific embodiment of the present invention, the demonstration surfaces [5] may be connected in a map-type formation, as shown in FIG. 1. In another embodiment, the map-type formation may be adapted to fit in a pocket. In another specific embodiment, the demonstration surfaces may be adapted to be connected in a ring-type formation. In another embodiment, the ring-type formation may include a ring and a plurality of demonstration surfaces adapted to hang from the ring, as shown in FIG. 2. In still another embodiment, the plurality of demonstration surfaces may be adapted to be removed from the ring. In a further embodiment, the demonstration surfaces may be adapted to be connected in a notebook-type formation, as depicted in FIG. 3.

In one embodiment of the present invention, the informative information may be adapted to be grouped into categories. In another embodiment of the present invention, the demonstration surfaces may be adapted to be water-resistant. In another embodiment of the present invention, the demonstration surfaces may be adapted to be tear-resistant. In a further embodiment, the demonstration surfaces may be adapted to be identical.

It is understood that both the foregoing general description and the following detailed description are exemplary and explanatory only and are not restrictive of the invention as claimed. The accompanying drawings illustrate several embodiments of the invention and together with the description serve to explain the principles of the invention.

### BRIEF DESCRIPTION OF THE DRAWINGS

FIG. 1 shows a map-type embodiment of the invention

FIG. 2 depicts the invention in which the demonstration surfaces are connected to a ring

FIG. 3 shows an embodiment in which the demonstration surfaces are connected in a notebook fashion.

FIG. 4 is a schematic diagram of a demonstration surface of the present invention designed for painting.

FIG. 5 is a schematic diagram of a demonstration surface of the present invention designed for landscaping.

FIG. 6 is a schematic diagram of a demonstration surface of the present invention designed for painting instructions.

FIG. 7 is a schematic diagram of a demonstration surface of the present invention designed for landscaping instructions.

FIG. 8 is a schematic diagram of a demonstration surface of the present invention designed for drywall instructions.

FIG. 9 is a schematic diagram of a demonstration surface of the present invention designed for irrigation instructions.

FIG. 10 is a schematic diagram of a demonstration surface of the present invention designed for questions related to painting.

FIG. 11 is a schematic diagram of a demonstration surface of the present invention designed for questions related to lawncare.

FIG. 12 is a schematic diagram of a demonstration surface of the present invention designed for questions related to irrigation.

FIG. 13 is a schematic diagram of a demonstration surface of the present invention designed for painting supplies.

FIG. 14 is a schematic diagram of a demonstration surface of the present invention designed for irrigation supplies.

FIG. 15 is a schematic diagram of a demonstration surface of the present invention designed for drywall supplies.

### DETAILED DESCRIPTION OF THE PREFERRED EMBODIMENTS

Reference will now be made in detail to the present preferred or exemplary embodiments of the invention, examples of which are illustrated in the accompanying drawings.

The invention encompasses a device and method for enabling communication in situations that present impediments to such communication. The impeding situations may include the following: language barriers, one party's lack of knowledge of a topic, or temporal barriers in which the communicating parties may not be in each other's presence. The invention is intended to enable communication in these situations by providing a graphic depiction of the information to be conveyed along with a verbal description in multiple languages. The language barrier may be overcome by use of the device's graphics and multiple languages; the knowledge barrier may be overcome by the device's graphics and associated verbal description; and the temporal barrier may be overcome by the either placing the device in a specific location for the other party to see at some later time, or by handing the device to the other party, wherein time spent face-to-face is minimized and the party receiving the information keeps the device for further reference. The last of these objectives may increase efficiency in situations where one person, e.g. a supervisor, must provide different instructions to multiple workers and has an incentive to minimize the time spent issuing instructions.

In a specific embodiment, the present invention relates to a non-verbal multilingual communication aid and to a method of non-verbal communication between individuals speaking different languages. The aid is designed to help with a particular task or theme. Some tasks may include painting, landscaping, irrigation, maid service/cleaning, elder/child care, drywall, general medical care, tasks performed in restaurants, etc.

Another embodiment of the invention provides assistance for those seeking certain services. The invention may be used to provide instructions on any of the following: opening a bank account, receiving vaccinations, interacting with the court system, registering a motor vehicle, purchasing real estate, obtaining housing, registering children in the school system, voting, obtaining insurance, getting medical care, and interacting with fire, police, and other emergency services. The communication aid is preferably designed in a variety of shapes and sizes to make it convenient for a particular task.

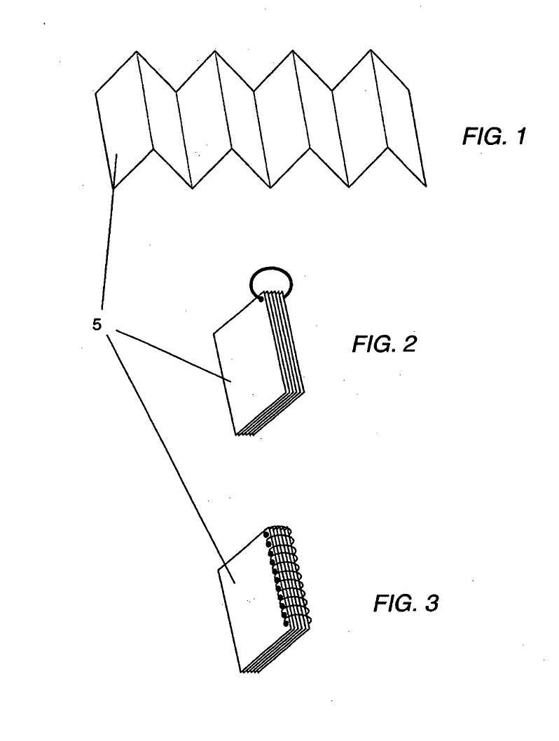

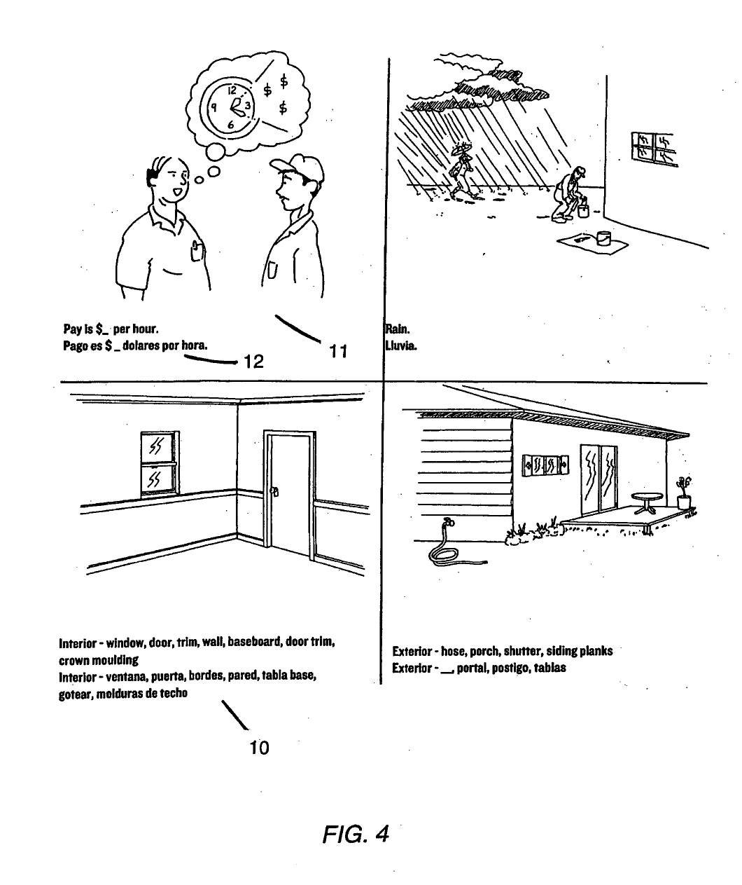

To achieve the objects and in accordance with the purpose of the invention, as embodied and broadly described herein, for example, FIG. 1 depicts a specific embodiment of the invention. The embodiment of the present invention depicted in FIG. 1 comprises a map style communication aid, the exemplary panels for which are depicted in FIG. 4-15. In a specific embodiment of the present invention, the communication aid is small enough to fit inside a pocket and may be unfolded to display a series of demonstration surfaces [5]. For example, when the communication is completely unfolded, it may have two sides and each side may have, for example, 8 panels. In one embodiment, one or more panels may include locations that depict the exterior and interior of a house, or building to be painted. Preferably, all types of communication aids are made of a sturdy material, capable of withstanding damage due to tearing or water, such as, for example, a plastic laminate.

The communication aid may be implemented in an electronic device, such as a laptop or a personal digital assistant (PDA). In this embodiment, the demonstration surfaces are displayed on the screen of the electronic device. Such an implementation may also have an audio playback feature, whereby the message corresponding to a demonstration surface is played in both languages. This would be especially useful for communicating with someone who is sight-impaired.

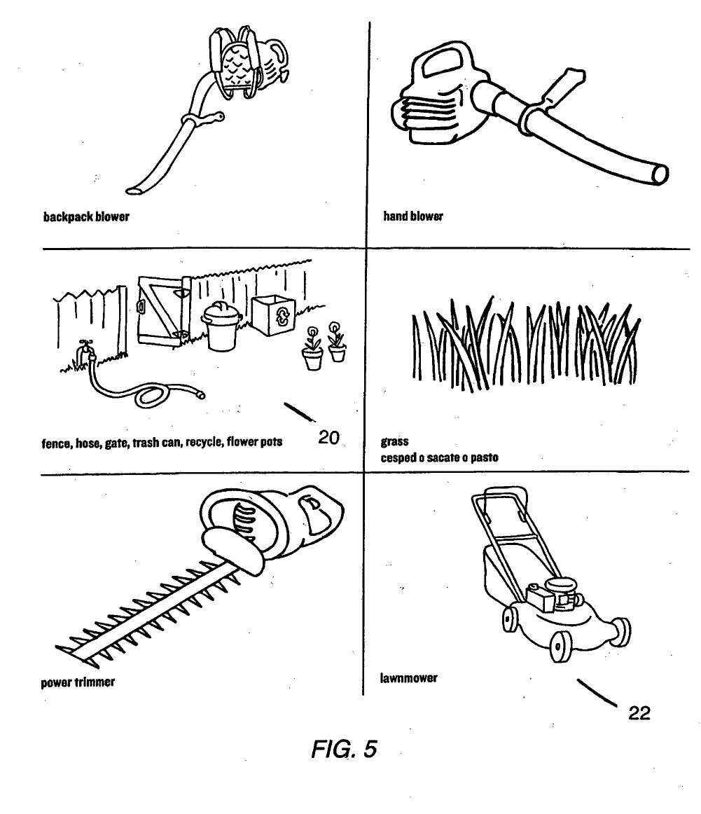

In the embodiment shown in FIG. 4, one side of the map is shown. In this embodiment, first panel [10], provides vocabulary related to locations. In a specific embodiment related to painting, possible locations may include the exterior of a structure, including siding, shutters, porches, garden hoses or scaffolds. Other possible locations may include the interior of a structure, and may also include specific fixtures or components in the interior of a structure such as crown molding, baseboards, door trim, and a door. In another embodiment related to landscaping as shown in FIG. 5, possible locations may include, for example a compost bag, or a garden. The locations are shown pictorially [20], and the name of each specific fixture or component is printed in close proximity to the pictorial representation of the location in at least two languages.

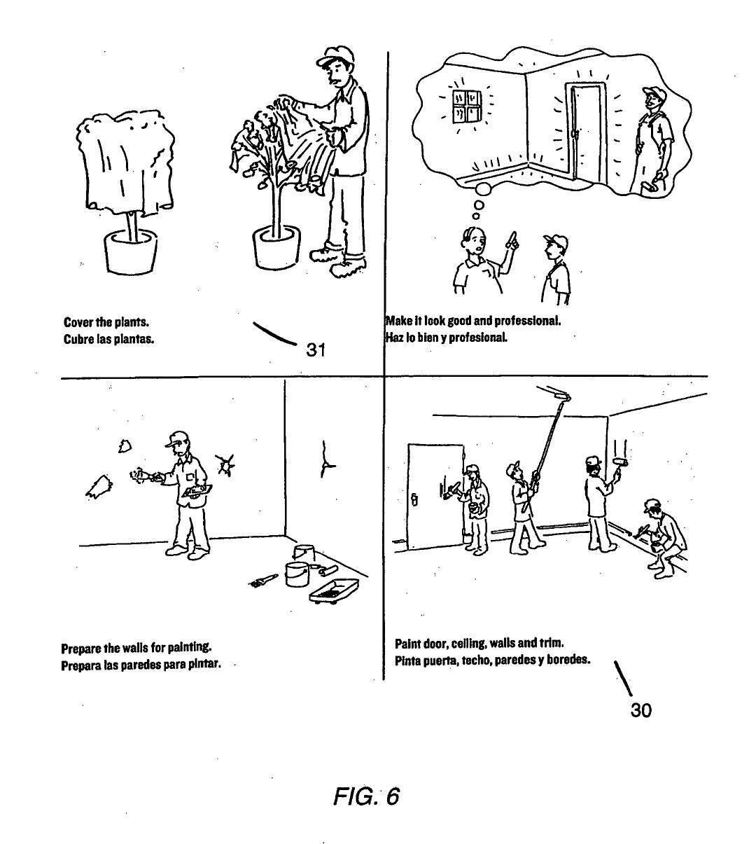

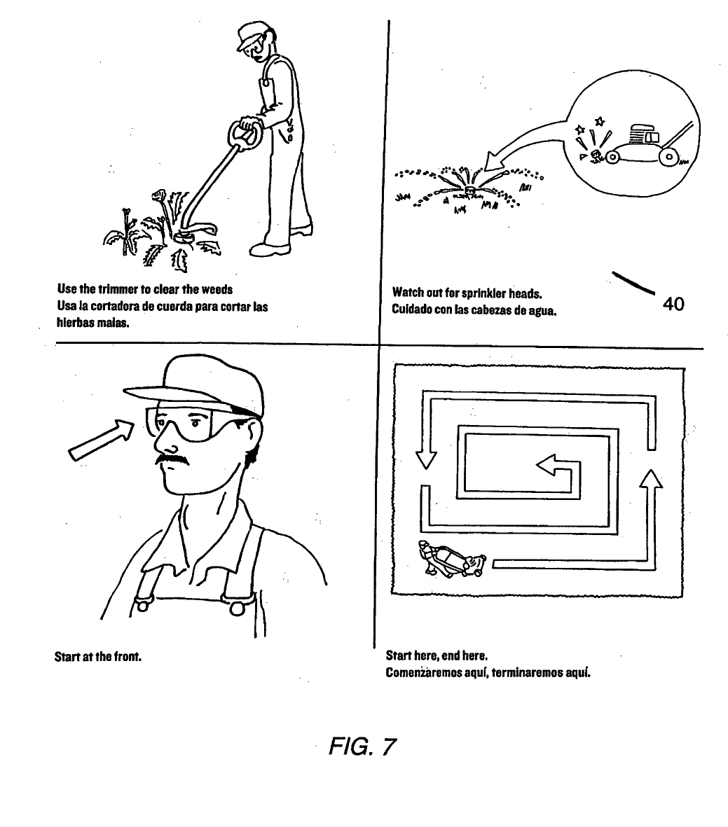

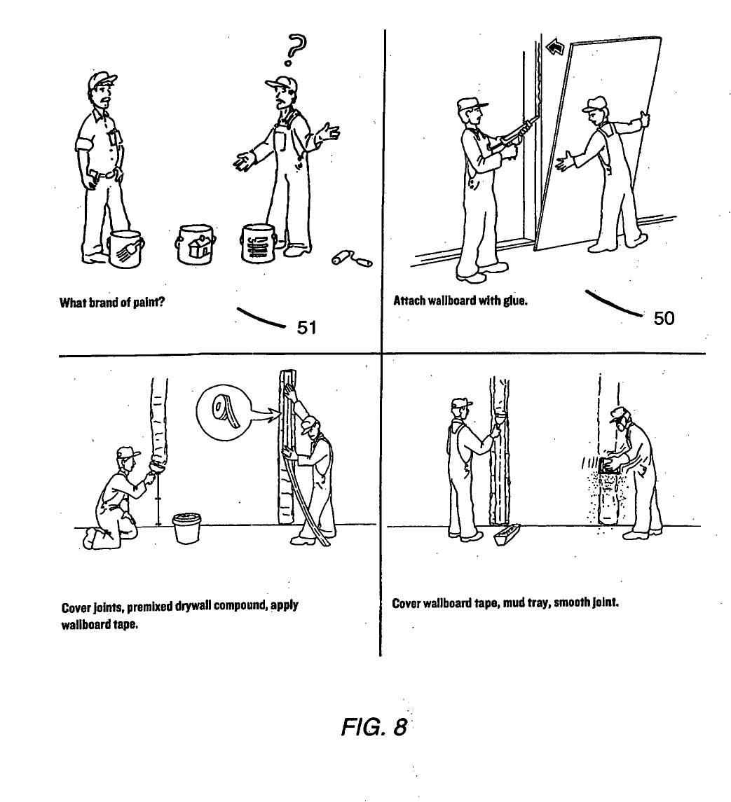

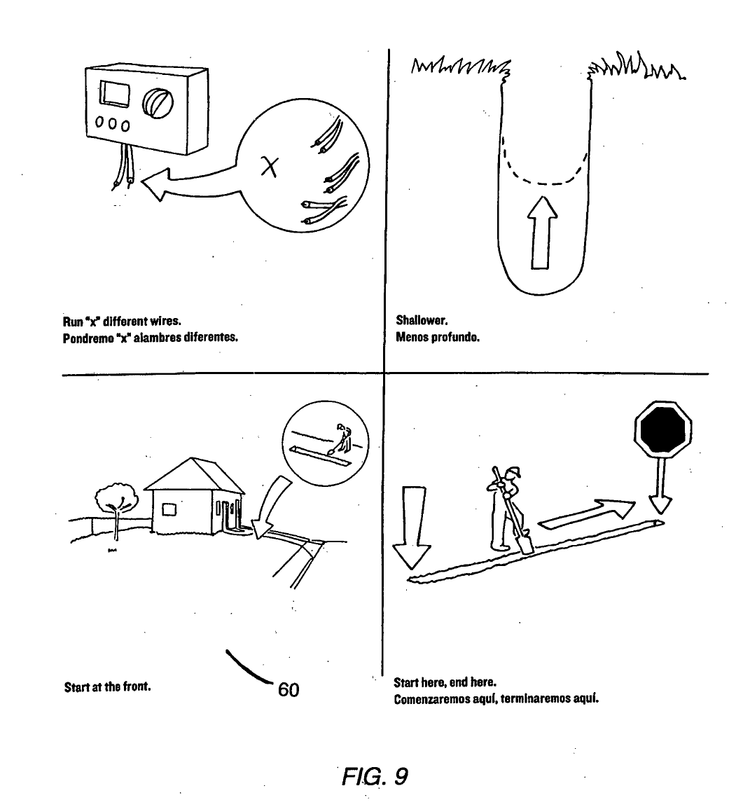

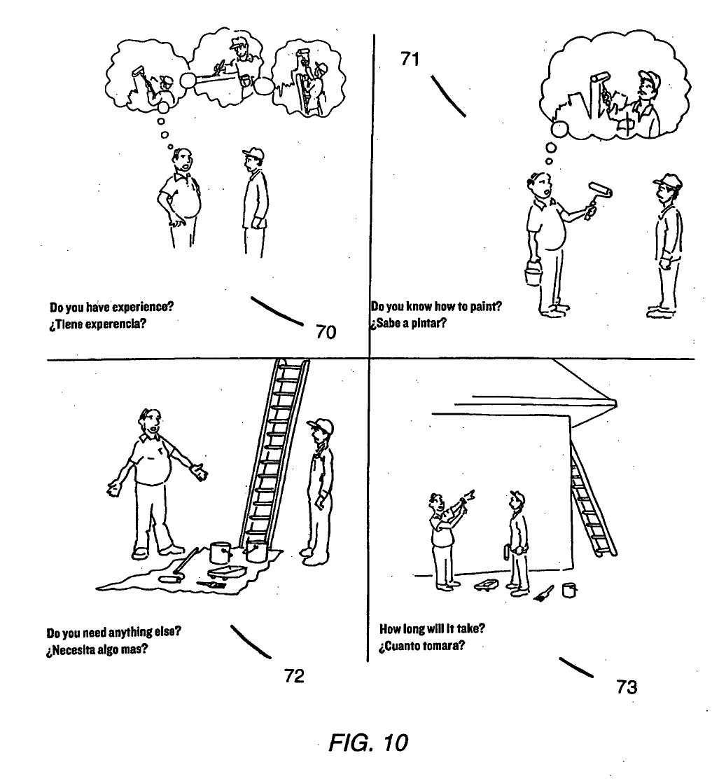

In another embodiment, one or more panels may include specific instructions related to a theme or task. In a specific embodiment, as shown in FIG. 6, these instructions may relate to a painting theme or task. Exemplary instructions may include apply coats; paint [30] walls, window, trim, door, and ceiling; clean up when you are finished; paint walls, windows, trim, and door; prepare the walls for priming; make it look good and professional; cover the plants [31]; clean the brushes; and cover the furniture. In another specific embodiment related to landscaping shown in FIG. 7, instructions may include, for example, watch out for sprinkler heads [40]; mow before trimming; mow diagonally; cut it shorter; trim along the fence; follow the sidewalk; trim the hedges; use a blower to clean up; use a broom to clean up; clean the yard; clean the gutters; sweep webs from the house; blades need to be sharpened; don't start before 8 am; too wet to mow; work here every two weeks; and do not work it if rains. Another possible specific embodiment includes drywalling as shown in FIG. 8. Instructions for drywalling may include pay in cash; attach wallboard with glue [50]; cover joints; apply wallboard tape; smooth joint; apply finish coat; wet sanding sponge; and smooth finish coat. A fourth possible specific embodiment relates to irrigation shown in FIG. 9. Instructions for irrigation may include start in the front [60]; trench this area first; remove all rocks; follow the paint markings when trenching; use stakes to hold line in place; make the heads level with the ground; use x inch tubing; and install the clock/control box here. The instructions are shown pictorially, and the name of each specific instruction is listed in close proximity to the pictorial representation of the instruction in at least two languages.

In one embodiment, one or more panels may have a surface that can be written on to convey task-specific information. As shown in FIG. 4, the hourly pay rate conveyed in panel [11] provides space for the user to write in a specific amount [12]. Another advantage of the ability to write on the surface is that, for example, a supervisor could write numbers on specific panels to provide a sequence of instructions. The person receiving the instructions would have the invention in their possession while working, enabling him or her to refer to it as needed. A supervisor could mark a group of cards, each indicating an intended recipient, and then distribute the cards among a group of workers. A variation of this embodiment has a demonstration surface that can be written on and is also erasable, enabling reuse of the card.

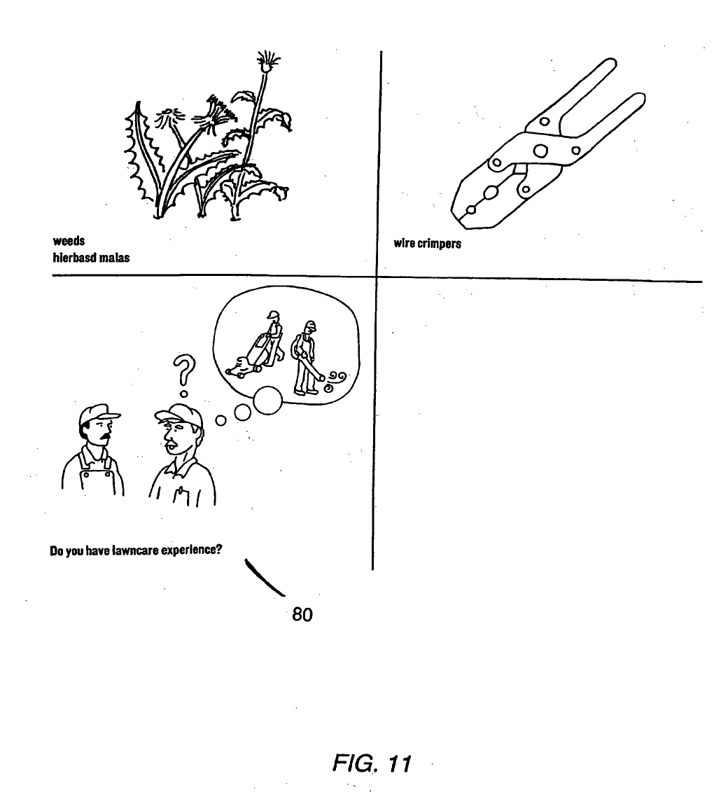

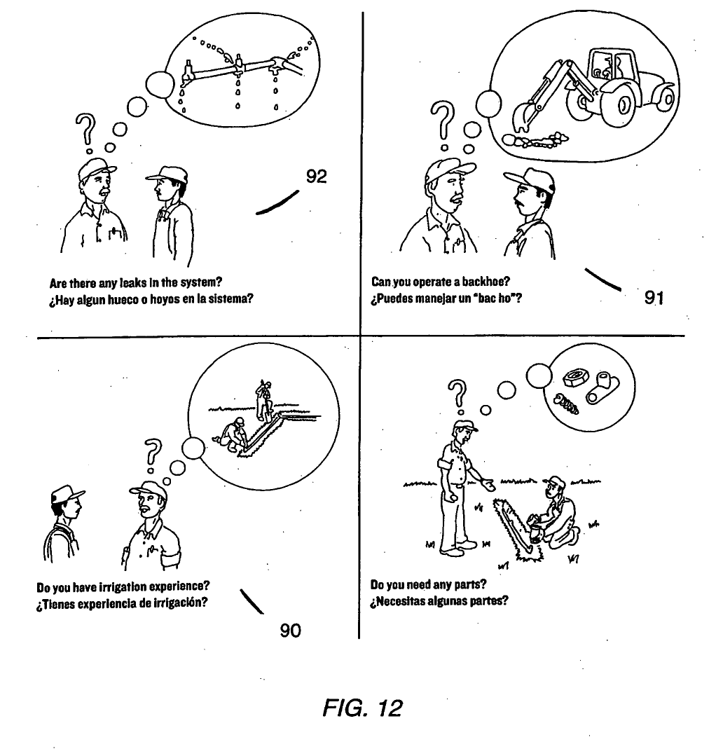

In one embodiment, one or more panels may include questions related to the theme or task. In a specific embodiment, as shown in FIG. 10, these questions may relate to a painting theme or task. The questions may include, for example, do you have experience [70]; do you know how to paint [71]; do you need anything else [72]; and how long will it take [73]. In another specific embodiment, questions may relate to landscaping as shown in FIG. 11. The questions may include, for example, do you have lawncare experience [80]. A third possible specific embodiment as shown in FIG. 8 includes drywalling. The questions related to a drywalling theme or task include, for example, what brand of paint [51]. A fourth possible specific embodiment includes irrigation as shown in FIG. 12. The questions related to an irrigation theme or task may include, for example, do you have any irrigation experience [90]; can you operate a backhoe [91]; do you need any parts; where is the problem; and are there any leaks in the system [92]. The questions are shown pictorially, and the specific question is printed in close proximity to the pictorial representation of the question in at least two languages.

In one embodiment, one or more panels may include measurement and other needed references, such as, for example, colors or shades. The references are shown pictorially or displayed, and the specific name is printed in close proximity to the pictorial representation of the reference in at least two languages.

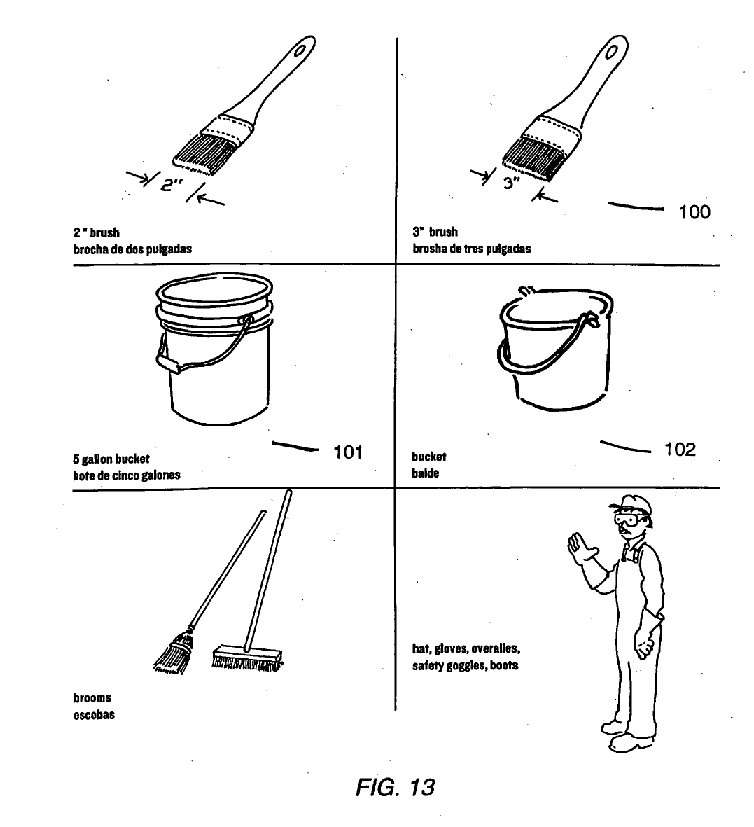

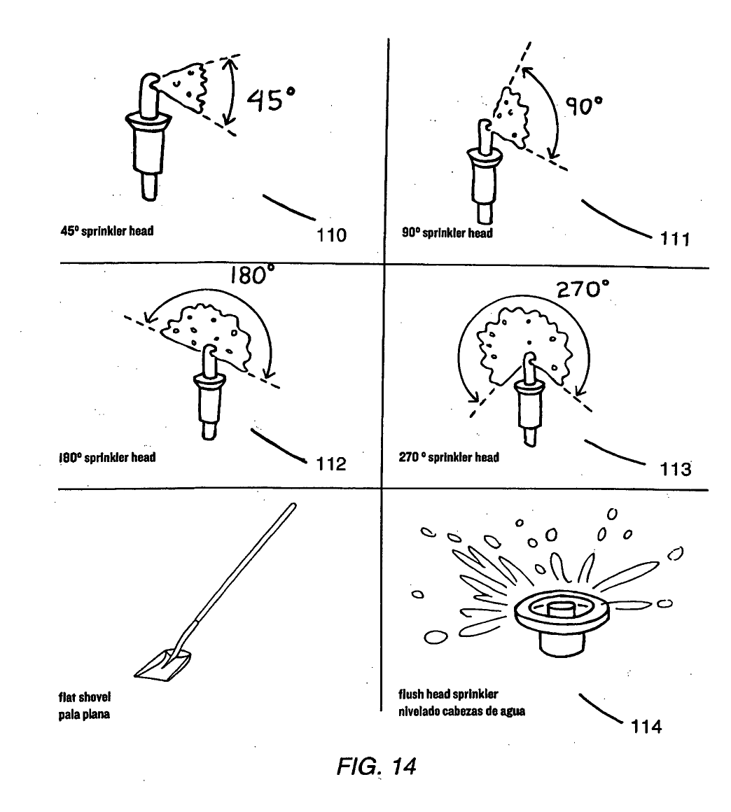

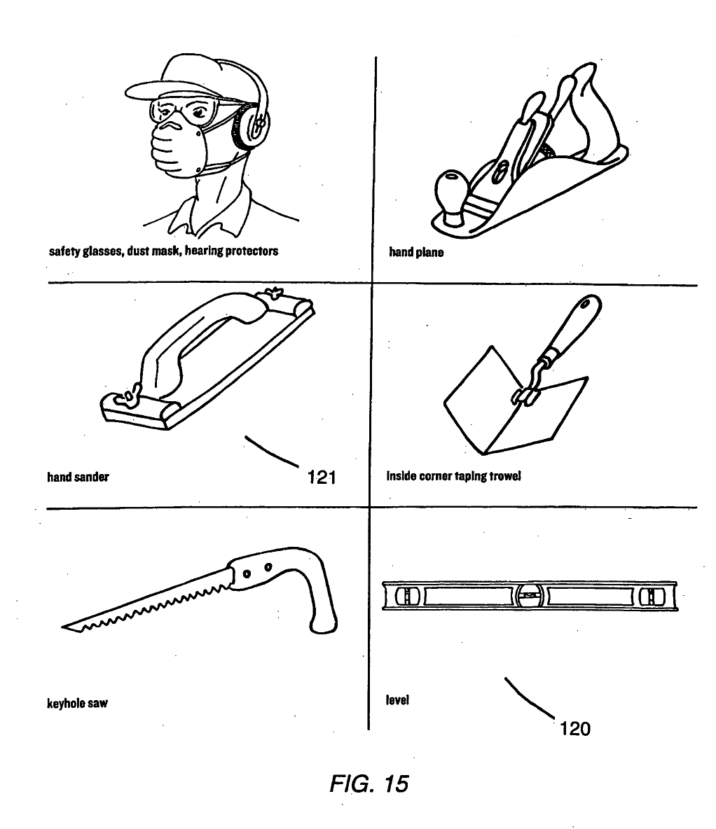

In another embodiment, one or more panels may include a list of supplies related to the theme or task. In a specific embodiment, as shown in FIG. 13, these supplies may relate to a painting theme or task. The supplies may include, for example, 3″ brush [100], 2″ brush, sash brush, foam brush, trim paint roller, wire brush, masking tape, 5 gallon bucket [101], bucket [102], paint pan, paint sprayer, putty knife, razor blade utility knife, stir sticks, dripping, paint can, rags, caulking, caulk gun, hammer, flat head screwdriver, Phillips screwdriver, plastic gloves, rubber gloves, paper towels, paint shield, sand paper, sanding block, broom, ladder, extension handle, roller cover, paint roller, cap, goggles, gloves, coveralls, sander, sanding, and drop cloth. In another specific embodiment related to landscaping as shown in FIG. 5, supplies may include, for example, wire crimpers; pruners; scissors; tree trimming saw; hedge trimmer; hand blower; grass; weeds; lawn mower [22]; fence; garbage can; and hose. In another specific embodiment as shown in FIG. 14, these supplies may relate to an irrigation theme or task. Examples of supplies may include, shovels; rakes; wheelbarrow; sod and bedding; 45° sprinkler [110]; 90° sprinkler [111]; 180° sprinkler [112]; 270° sprinkler [113]; pop-up sprinkler; flush sprinkler [114]; impact sprinkler; rocks; gravel; soil; and fertilizer. In a fourth specific embodiment related to drywall as shown in FIG. 15, supplies include, for example, tape measure; pencils; paint pad; level [120]; putty knife; pointed trowel; hand sander [121]; power drill; saber saw; stapler; stud locator; can of spackle; premixed drywall compound; and metal corner bead and drywall nails. The supplies are preferably shown pictorially, and the name of the supply is printed in close proximity to the pictorial representation of the supply in at least two languages.

In the above embodiment, the demonstration surface may be writeable such that the user wishing to provide task-specific information may mark the demonstration surface to, for example, instruct the painter on which paint brush to use. This enables the selection of one or more instructions from among alternative instructions depicted on the card. Using the invention in this manner provides the ability to communicate indirectly whereby a supervisor may place an appropriately marked card at the location where the painting is to be done. In this manner, cards could be placed at specific locations where work is to be done, enabling the efficient dissemination of information throughout a work site.

In another embodiment of the present invention, the non-verbal communication aid may be a key ring style communication aid, shown in FIG. 3. In this embodiment, various “keys” or cards are contained on a key ring. The key ring may be easily opened or close to remove a desired card. Each card is preferably made of a sturdy material, capable of resisting damage such as water or tearing. This particular embodiment may be useful in conjunction with maid service. For example, each card may represent a different cleaning task, such as vacuum, sweep, dust, wash, or change, or wash. Each card preferably has a pictorial representation of a task, and the name of the specific task printed in close proximity to the pictorial representation of the task in at least two languages. There may be multiple cards or keys for the same task on the key ring. In one embodiment, there may be about 70 cards on the ring.

In a method using the map-type aid of the present invention, a person who wants a particular task to be performed would unfold the map and point to a particular panel. For example, if a contractor or foreman wanted a day-laborer who does not speak English to paint a room inside a house, he would select a particular portion of a panel, such as for example, a panel with questions and point to the portion that shows the question “do you have experience.” The day-laborer may recognize the Spanish question “tiene experiencia” or would know from the picture on the panel, what the contractor or foreman is asking and could respond appropriately. The contractor or foreman would then point to the desired task such as, for example, “paint walls, windows, trim, door and ceiling.” The day laborer may recognize the Spanish instruction of “pinta paredes, ventana, bordes, puerta y cielos rasos” or would know what to do from the illustration on the panel.

In a method using the key-ring style communication ring, a homeowner, for example, could leave instructions for a maid that speaks a different language from the homeowner by leaving the appropriate key in a specific location. For example, a card that reads “white clothes” in two languages and a card that reads “wash” may be removed from the key ring and placed on a laundry basket by the homeowner. If the cards are designed for English and Spanish speakers, the maid may recognize the Spanish “ropa blanca” and “lavar” or would know what to do from the illustration on the card.

Other embodiments of the invention will be apparent to those skilled in the art from consideration of the specification and the practice of the invention disclosed herein. It is intended that the specification and examples be considered as exemplary only, with a true scope and spirit of the invention being indicated by the following claims.

1. A multilingual communication aid device comprising a plurality of demonstration surfaces, wherein each demonstration surface contains informative task specific information in at least two languages and a pictorial representation of the informative task specific information.

2. The communication aid as claimed in claim 1, wherein said aid is categorized into a particular task.

3. The communication aid as claimed in claim 2, wherein said task is selected from the group consisting of painting, irrigating, landscaping, construction, maid service, drywall, and food service.

4. The communication aid as claimed in claim 1, wherein said aid is categorized into a particular service.

5. The communication aid as claimed in claim 4, wherein said service includes at least one of the following:
opening a bank account;
receiving vaccinations;
interacting with the court system;
registering a motor vehicle;
purchasing real estate;
obtaining housing;
registering children in the school system;
voting;
obtaining insurance;
getting medical care; and
interacting with fire, police, and other emergency services.

6. The communication aid as claimed in claim 1, wherein the communication aid can be folded.

7. The communication aid as claimed in claim 1, wherein said demonstration surfaces are connected by a ring.

8. The communication aid as claimed in claim 1, wherein said demonstration surfaces are connected by a plurality of rings.

9. The communication aid as claimed in claim 1, wherein said informative information is grouped into categories.

10. The communication aid as claimed in claim 1, wherein said demonstration surfaces are water-resistant.

11. The communication aid as claimed in claim 1, wherein said demonstration surfaces are tear-resistant.

12. The communication aid as claimed in claim 1, wherein said demonstration surfaces are printed in colors which make them difficult to photocopy.

13. The communication aid as claimed in claim 1, wherein said demonstration surfaces can be written on.

14. The communication aid as claimed in claim 1, wherein said demonstration surfaces can be written, and the writing can be erased.

15. The communication aid as claimed in claim 1, wherein the communication aid is an electronic device, wherein the demonstration surface is displayed on a screen integral to the electronic device.

16. The communication aid as claimed in claim 15, wherein the electronic device is a personal digital assistant (PDA).

17. The communication aid as claimed in claim 15, wherein the electronic device is a laptop computer.

18. The communication aid as claimed in claim 15, wherein the electronic device stores and plays audio information corresponding to the demonstration surface.

19. The communication aid as claimed in claim 6, wherein the communication aid is small enough to fit inside a pocket when the communication aid is folded.

20. The communication aid as claimed in claim 7, wherein the plurality of demonstration surfaces are adapted to hang from said ring.

21. The communication aid as claimed in claim 20, wherein said plurality of demonstration surfaces are adapted to be removed from said ring.

22. The communication aid as claimed in claim 21, wherein the demonstration surfaces are pocket-size.

23. The communication aid as claimed in claim 7, wherein one or more demonstration surfaces are identical.

24. The communication aid as claimed in claim 9, wherein said categories are selected from the group consisting of locations, instructions, questions, and supplies.

25. The communication aid as claimed in claim 24, wherein the instructions category comprises a sequence of instructions.

26. The communication aid as claimed in claim 24, wherein the instructions category comprises a set of alternative instructions.

27. A method of non-verbal communication comprising the steps of: providing a communication aid, wherein said communication aid comprises a plurality of demonstration surfaces, wherein each surface contains informative task specific information in at least two languages and a pictorial representation of the informative task specific information;
selecting a desired demonstration surface; and
indicating the relevant information on the demonstration surface.

28. The method as claimed in claim 27, wherein the indicating step further comprises pointing to a particular panel.

29. The method as claimed in claim 27, wherein the indicating step further comprises placing the demonstration surface in a desired location.

30. The method as claimed in claim 27, wherein the plurality of demonstration surfaces are placed at a plurality of locations specific to accomplishing a set of tasks.

31. The method as claimed in claim 27, wherein the indicating step further comprises writing information on the demonstration surface.

32. The method as claimed in claim 31, wherein each demonstration surface among the plurality of demonstration surfaces is marked to indicate an intended recipient among a plurality of possible recipients.

33. The method as claimed in claim 31, wherein the writing indicates the selection of one or more demonstration surfaces panels from among alternatives.

34. The method as claimed in claim 31, wherein the writing contains task-specific information including one or more of the following:
pay rate per hour;
start and stop time of a task;
selection of supplies to use for a specific task; and
the order in which depicted tasks are to be performed.

35. The method as claimed in claim 31, further comprising the step of erasing the written information.

36. The method as claimed in claim 31, further comprising the step wherein the a person receiving the information carries the communication aid in a pocket while performing a task depicted on the communication aid.
